(19) United States
(12) Patent Application Publication
(10) Pub. No.: US 2026/0270696 A1
(43) Pub. Date: Sep. 10, 2026

(54) AUTHENTICATION AND AUTHORIZATION METHOD AND APPARATUS, COMMUNICATION DEVICE AND STORAGE MEDIUM

(71) Applicant: Beijing Xiaomi Mobile Software Co., Ltd., Beijing (CN)

(72) Inventors: Haoran LIANG, Beijing (CN); Wei LU, Beijing (CN)

(21) Appl. No.: 18/875,667

(22) PCT Filed: Jun. 17, 2022
(86) PCT No.: PCT/CN2022/099632

§ 371 Date: Dec. 16, 2024

(51) Int. Cl. H04W 12/06; H04W 12/041

(52) U.S. Cl. CPC H04W 12/06; H04W 12/041

(57) ABSTRACT

An authentication and authorization method, includes: transmitting authentication and authorization information to an edge configuration server (ECS); wherein the authentication and authorization information is configured to request a token for service authorization.

### CROSS-REFERENCE TO RELATED APPLICATION

The present application is a U.S. National Phase of International Patent Application Serial No. PCT/CN2022/099632 filed on Jun. 17, 2022. The contents of this application are hereby incorporated by reference in their entirety for all purposes.

### BACKGROUND OF THE INVENTION

In the radio communication technology, how to authenticate and authorize an edge enabler client (EEC) hosted in a roaming terminal to visit an edge computation service available in a visited public land mobile network (VPLMN) is to be determined. A roaming user needs to be authorized by a home location carrier and a visit location carrier before visiting an edge application in the network.

### SUMMARY OF THE INVENTION

Examples of the disclosure disclose a method and apparatus for authentication and authorization, a communication device, and a storage medium.

According to a first aspect of the examples of the disclosure, a method for authentication and authorization is provided. The method is performed by an edge enabler client (EEC). The method includes:
transmitting authentication and authorization information to an edge configuration server (ECS); where
the authentication and authorization information is configured to request a token for service authorization.

According to a second aspect of the examples of the disclosure, a method for authentication and authorization is provided. The method is performed by an edge configuration server (ECS). The method includes:
receiving authentication and authorization information transmitted by an edge enabler client (EEC); where
the authentication and authorization information is configured to request a token for service authorization.

According to a third aspect of the examples of the disclosure, a method for authentication and authorization is provided. The method is performed by a Zn interface proxy Zn-Proxy. The method includes:
receiving application request information transmitted by an ECS; where
the application request information includes at least one of:
a bootstrapping transaction identifier (B-TID) received by the ECS;
a network application function (NAF) identifier (ID); and
a key type indicator.

According to a fourth aspect of the examples of the disclosure, a method for authentication and authorization is provided. The method is performed by a bootstrapping server function (BSF). The method includes:
receiving application request information transmitted by a Zn-Proxy; where
the application request information includes at least one of:
a B-TID received by an ECS;
a network application function (NAF) identifier (ID); and
a key type indicator.

According to a fifth aspect of the examples of the disclosure, a communication device is provided. The communication device includes:
one or more processors; and
a memory configured to store a processor-executable instruction; where
the one or more processors are configured to implement the method according to any example of the disclosure when running the executable instruction.

According to a sixth aspect of the examples of the disclosure, a non-transitory computer storage medium is provided. The non-transitory computer storage medium stores a computer-executable program, where the executable program implements the method according to any example of the disclosure when executed by a processor.

### BRIEF DESCRIPTION OF DRAWINGS

FIG. 1 is a schematic structural diagram of a radio communication system according to an example.

FIG. 2 is a schematic flowchart of a method for authentication and authorization according to an example.

FIG. 3 is a schematic flowchart of another method for authentication and authorization according to an example.

FIG. 4 is a schematic flowchart of yet another method for authentication and authorization according to an example.

FIG. 5 is a schematic flowchart of yet another method for authentication and authorization according to an example.

FIG. 6 is a schematic flowchart of yet another method for authentication and authorization according to an example.

FIG. 7 is a schematic flowchart of yet another method for authentication and authorization according to an example.

FIG. 8 is a schematic flowchart of yet another method for authentication and authorization according to an example.

FIG. 9 is a schematic flowchart of yet another method for authentication and authorization according to an example.

FIG. 10 is a schematic flowchart of yet another method for authentication and authorization according to an example.

FIG. 11 is a schematic flowchart of yet another method for authentication and authorization according to an example.

FIG. 12 is a schematic flowchart of yet another method for authentication and authorization according to an example.

FIG. 13 is a schematic flowchart of yet another method for authentication and authorization according to an example.

FIG. 14 is a schematic flowchart of yet another method for authentication and authorization according to an example.

FIG. 15 is a schematic flowchart of yet another method for authentication and authorization according to an example.

FIG. 16 is a schematic flowchart of yet another method for authentication and authorization according to an example.

FIG. 17 is a schematic flowchart of yet another method for authentication and authorization according to an example.

FIG. 18 is a schematic flowchart of yet another method for authentication and authorization according to an example.

FIG. 19 is a schematic flowchart of yet another method for authentication and authorization according to an example.

FIG. 20 is a schematic flowchart of still another method for authentication and authorization according to an example.

FIG. 21 is a schematic structural diagram of an apparatus for authentication and authorization according to an example.

FIG. 22 is a schematic structural diagram of another apparatus for authentication and authorization according to an example.

FIG. 23 is a schematic structural diagram of yet another apparatus for authentication and authorization according to an example.

FIG. 24 is a schematic structural diagram of still another apparatus for authentication and authorization according to an example.

FIG. 25 is a schematic structural diagram of a terminal according to an example.

FIG. 26 is a block diagram of a base station according to an example.

### DETAILED DESCRIPTION OF THE INVENTION

Examples will be described in detail here, and their instances are shown in the accompanying drawings. When the following description involves the accompanying drawings, the same numerals in different accompanying drawings indicate the same or similar elements unless otherwise indicated. Embodiments described in the following examples do not denote all embodiments consistent with the examples of the disclosure. On the contrary, these embodiments are merely instances of apparatuses and methods consistent with some aspects of the examples of the disclosure as detailed in the appended claims.

Terms used in the examples of the disclosure are merely used for describing specific examples rather than limiting the examples of the disclosure. Singular forms such as “a”, “an”, “the” and “this” used in examples and the appended claims of the disclosure are also intended to include plural forms, unless otherwise clearly stated in the context. It should also be understood that the term “and/or” used here indicates and includes any or all possible combinations of one or more of associated listed items.

It should be understood that although terms such as first, second and third can be used in the examples of the disclosure to describe different types of information, the information should not be limited to these terms. These terms are merely used for distinguishing the same type of information from each other. For example, first information can also be referred to as second information and the second information can also be referred to as the first information similarly without departing from the scope of examples of the disclosure. Depending on the context, the word “if” as used here can be interpreted as “at the time of” or “when” or “in response to determining”.

For purposes of concision and ease of understanding, the term “greater than” or “less than” is used here to represent a size relation. Those skilled in that art can understand that the term “greater than” also covers the meaning of “greater than or equal to”, and the term “less than” also covers the meaning of “less than or equal to”.

The disclosure relates to, but is not limited to, the technical field of radio communication, in particular to a method and apparatus for authentication and authorization, a communication device, and a storage medium.

In the radio communication technology, how to authenticate and authorize an edge enabler client (EEC) hosted in a roaming terminal to visit an edge computation service available in a visited public land mobile network (VPLMN) is to be determined. A roaming user needs to be authorized by a home location carrier and a visit location carrier before visiting an edge application in the network. In the related art, an edge configuration server (ECS) cannot authenticate and authorize the EEC in a roaming scenario.

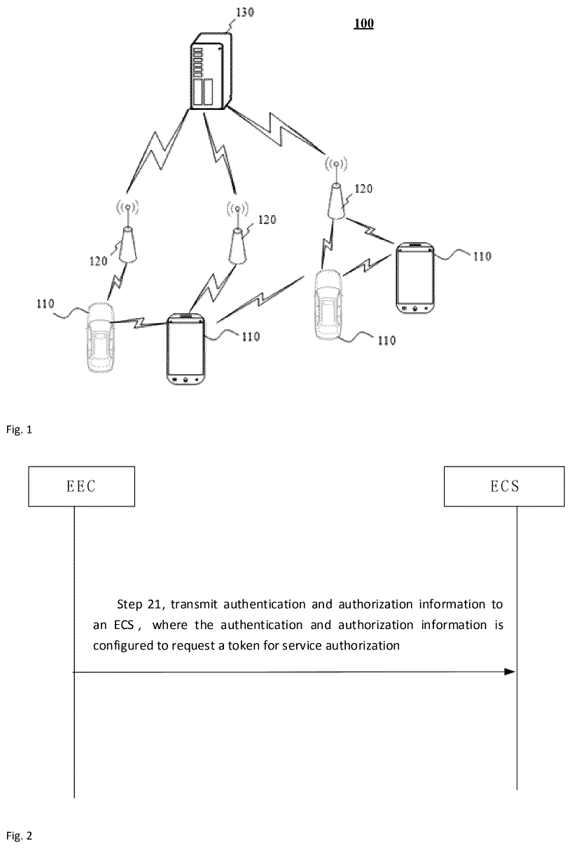

With reference to FIG. 1, a schematic structural diagram of a radio communication system 100 according to an example of the disclosure is shown. As shown in FIG. 1, the radio communication system 100 is a communication system based on mobile communication technology. The radio communication system 100 may include several pieces of user equipment 110 and several base stations 120.

The user equipment 110 may be a device that provides voice and/or data connectivity for a user. The user equipment 110 may communicate with one or more core networks via a radio access network (RAN). The user equipment 110 may be Internet of Things user equipment, such as a sensor device, a mobile phone and a computer with the Internet of Things user equipment. For example, the user equipment may be a fixed, portable, pocket-type, handheld, computer built-in or vehicle-mounted apparatus. For example, the user equipment may be a station (STA), a subscriber unit, a subscriber station, a mobile station, a mobile, a remote station, an access point, a remote terminal, an access terminal, a user terminal, a user agent, a user device or user equipment. Alternatively, the user equipment 110 may also be a device of an unmanned aerial vehicle. Alternatively, the user equipment 110 may be a vehicle-mounted device, for example, an electronic control unit having a radio communication function, or radio user equipment externally connected to the electronic control unit. Alternatively, the user equipment 110 may also be a roadside device, such as a street lamp, a signal lamp or other roadside devices having a radio communication function.

The base station 120 may be a network-side device in the radio communication system 100. The radio communication system 100 may be the 4^{th} generation mobile communication (4G) system, also referred to as a long term evolution (LTE) system, or the radio communication system 100 may be a 5G system, also referred to as a new radio system or a 5G NR system. Alternatively, the radio communication system 100 may be a next generation system after the 5G system. An access network in the 5G system may be referred to as a new generation-radio access network (NG-RAN).

The base station 120 may be an evolved base station (eNB) used in the 4G system. Alternatively, the base station 120 may be a base station (gNB) adopting a central distributed architecture in the 5G system. When adopting the central distributed architecture, the base station 120 typically includes a central unit (CU) and at least two distributed units (DUs). Protocol stacks of a packet data convergence protocol (PDCP) layer, a radio link control (RLC) layer and a media access control (MAC) layer are arranged in the central unit. A physical (PHY) layer protocol stack is arranged in the distributed unit. A specific implementation of the base station 120 is not limited in the example of the disclosure.

A radio connection may be established between the base station 120 and the user equipment 110 through radio. In different embodiments, the radio is radio based on the fourth generation mobile communication network technology (4G) standard, or the radio is radio based on the fifth generation mobile communication network technology (5G) standard, for example, the radio is new radio, or the radio may also be radio based on the next generation mobile communication network technology standard after 5G.

In some examples, an end to end (E2E) connection may also be established between the user equipment 110, for example, vehicle to vehicle (V2V) communication, vehicle to infrastructure (V2I) communication and vehicle to pedestrian (V2P) communication in vehicle to everything (V2X).

Here, the user equipment described above may be considered as a terminal device in the following example.

In some examples, the radio communication system 100 above may further include a network management device 130.

Several base stations 120 are separately connected to the network management device 130. The network management device 130 may be a core network device in the radio communication system 100, for example, the network management device 130 may be a mobility management entity (MME) in an evolved packet core network (EPC). Alternatively, the network management device may also be other core network devices, such as a serving gateway (SGW), a public data network gateway (PGW), a policy and charging rules function (PCRF) or a home subscriber server (HSS). An implementation form of the network management device 130 is not limited in the example of the disclosure.

For the convenience of understanding by those skilled in the art, the technical solutions of the examples of the disclosure are clearly described by enumerating a plurality of embodiments in the examples of the disclosure. It is clear that those skilled in the art can understand that a plurality of examples provided by the examples of the disclosure can be executed separately, or can be executed in combination with the methods of the other examples of the disclosure, or can be further executed separately or in combination with some methods in other related arts, which is not limited in the example of the disclosure.

As shown in FIG. 2, a method for authentication and authorization is provided by this example. The method is performed by an edge enabler client (EEC). The method includes:
Step 21, authentication and authorization information is transmitted to an edge configuration server (ECS).

The authentication and authorization information is configured to request a token for service authorization.

Here, a terminal involved in the disclosure may be, but is not limited to, a mobile phone, a wearable device, a vehicle-mounted terminal, a road side unit (RSU), a smart home terminal, an industrial sensing device and/or a medical device. In some examples, the terminal may be a Redcap terminal or a new radio (NR) terminal of a predetermined version (for example, a NR terminal of R17). The terminal may be registered in a home network. The terminal may obtain a bootstrapping transaction identifier (B-TID) from a bootstrapping server function (BSF) of the home network of the EEC during running of a generic bootstrapping architecture (GBA). By treating the ECS as a network application function (NAF), different types of keys, for example, Ks_NAF, Ks_int_NAF and Ks_ext_NAF, may be computed according to an NAF identifier (ID) of an edge enabler server (EES). The terminal may select one of the keys as K_{ECS}. In an example, the terminal may derive K_{EEC-ECS} based on the K_{ECS} and an EEC ID. The K_{EEC-ECS} may be derived by using a key derivation function (KDF). The EEC ID is used as an input parameter of the KDF and the K_{EES} is used as a key for deriving the K_{EEC-ECS}.

Here, the edge enabler client (EEC) may be an application, such as WeChat application and Weibo application, run on the terminal.

It should be noted that in the example of the disclosure, the EES is deployed in an operator domain and trusted by an operator. The EEC and the ECS may communicate with each other wirelessly based on a radio communication network. The radio communication network may be, but is not limited to, a 4G or 5G radio communication network, and may also be other evolved radio communication networks, which is not limited here.

In an example, the authentication and authorization information may be configuration request information for requesting the token.

In an example, the authentication and authorization information is transmitted to the edge configuration server (ECS). The authentication and authorization information is configured to request the token for the service authorization. The authentication and authorization information includes at least one of:
a bootstrapping transaction identifier (B-TID);
an encrypted EEC identifier (ID), where the encrypted EEC ID is encrypted based on the key K_{ECS};
a key type indicator; where the key type indicator may be a character string, for example, Ks_int_NAF, and is used as a key K_{EES};
a generic public subscription identifier (GPSI); and
a message authentication code.

It should be noted that the message authentication code is a message authentication code for integrity (MAC-I) determined based on the K_{ECS}, and is configured to protect integrity of the B-TID, the encrypted EEC ID, the GPSI and/or the key type indicator. It should be noted that the message authentication code MAC-I is generated based on a protected message and the K_{ECS}.

In an example, the EEC may obtain the B-TID from the bootstrapping server function (BSF) of the home network of the EEC during the running of the generic bootstrapping architecture (GBA).

In an example, the authentication and authorization information is transmitted to the edge configuration server (ECS). The authentication and authorization information is configured to request the token for the service authorization. The token transmitted by the ECS is received.

In an example, the authentication and authorization information is transmitted to the edge configuration server (ECS). The authentication and authorization information is configured to request the token for the service authorization. The token transmitted by the ECS is received through a transport layer security connection (TLS).

In an example, the token includes at least one piece of the following information:
a fully qualified domain name (FQDN) of the ECS;
the EEC identifier (ID);
a GPSI;
an expected edge enabler server (EES) service name;
an FQDN of the EES;
effective time; and
a digital signature.

In an example, the key K_{EEC-ECS} is determined based on the key K_{ECS} and the EEC identifier (ID). The key K_{EEC-ECS} is configured to execute mutual identity authentication and/or establishment of the transport layer security (TLS) connection between the EEC and the ECS.

In the example of the disclosure, the authentication and authorization information is transmitted to the edge configuration server (ECS). The authentication and authorization information is configured to request the token for the service authorization. Here, since the authentication and authorization information carries the token for requesting the service authorization, the ECS can transmit the token for the service authorization or reject transmission of the token for the service authorization after receiving the authentication and authorization information. Thus, security of an edge service can be improved compared with a method adopting an unauthorized process.

It should be noted that those skilled in the art can understand that the method according to the example of the disclosure can be executed separately, or can be executed along with some methods in the examples of the disclosure or some methods in the related art.

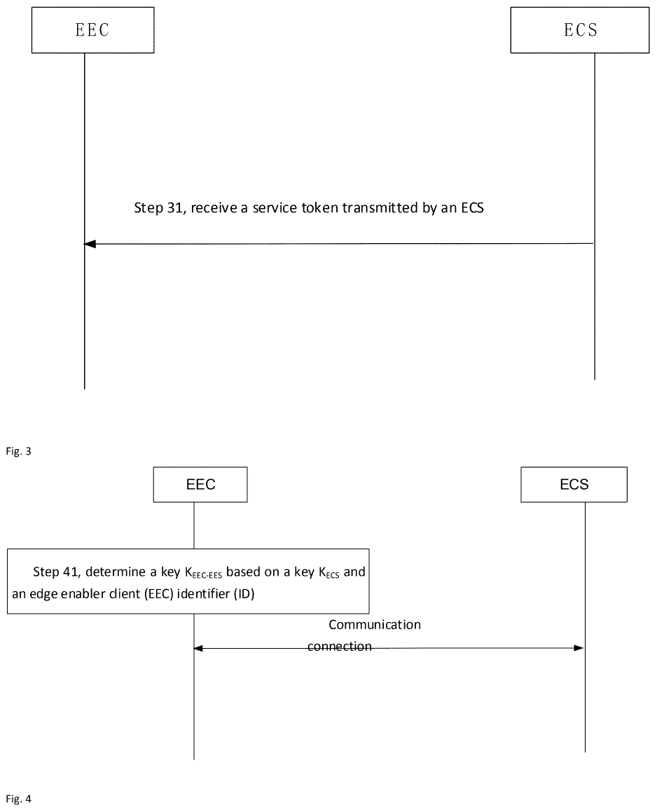

As shown in FIG. 3, another method for authentication and authorization is provided by this example. The method is performed by an edge enabler client (EEC). The method includes:
Step 31, a service token transmitted by an ECS is received.

In an example, authentication and authorization information is transmitted to the edge configuration server (ECS). The authentication and authorization information is configured to request the token for service authorization. The token transmitted by the ECS is received. The authentication and authorization information includes at least one of:
a bootstrapping transaction identifier (B-TID);
an encrypted EEC identifier (ID), where the encrypted EEC ID is encrypted based on a key K_{ECS};
a key type indicator; where the key type indicator may be a character string, for example, Ks_int_NAF, and is used as a key of a K_{EES};
a generic public subscription identifier (GPSI); and
a message authentication code.

It should be noted that the message authentication code is an MAC-I determined based on the K_{ECS}, and is configured to protect integrity of the B-TID, the encrypted EEC ID, the GPSI and/or the key type indicator.

In an example, the EEC may obtain the B-TID from a bootstrapping server function (BSF) of a home network of the EEC during running of a generic bootstrapping architecture (GBA).

In an example, the authentication and authorization information is transmitted to the edge configuration server (ECS). The authentication and authorization information is configured to request the token for the service authorization. The token transmitted by the ECS is received through a transport layer security connection (TLS).

In an example, the token includes at least one piece of the following information:
a fully qualified domain name (FQDN) of the ECS;
the EEC identifier (ID);
a GPSI;
an expected EES service name;
an FQDN of an EES;
effective time; and
a digital signature.

In an example, a key K_{EEC-ECS} is determined based on the key K_{ECS} and the EEC identifier (ID). The key K_{EEC-ECS} is configured to execute mutual identity authentication and/or establishment of the transport layer security (TLS) connection between the EEC and the ECS.

It should be noted that those skilled in the art can understand that the method according to the example of the disclosure can be executed separately, or can be executed along with some methods in the examples of the disclosure or some methods in the related art.

As shown in FIG. 4, yet another method for authentication and authorization is provided by this example. The method is performed by an edge enabler client (EEC). The method includes:
Step 41, a key K_{EEC-ECS} is determined based on a key K_{ECS} and an EEC identifier (ID).

The key K_{EEC-ECS} is configured to execute mutual identity authentication and/or establishment of a transport layer security (TLS) connection between the EEC and an ECS.

In an example, different types of keys, for example, Ks_NAF, Ks_int_NAF and Ks_ext_NAF, may be computed according to an NAF ID of the ECS. A terminal may select one of the keys as the K_{ECS}.

In an example, the key K_{EEC-ECS} is determined based on the key K_{ECS} and the EEC identifier (ID). The mutual identity authentication and/or the establishment of the transport layer security (TLS) connection are/is executed between the EEC and the ECS based on the key K_{EEC-ECS}.

It should be noted that those skilled in the art can understand that the method according to the example of the disclosure can be executed separately, or can be executed along with some methods in the examples of the disclosure or some methods in the related art.

As shown in FIG. 5, yet another method for authentication and authorization is provided by this example. The method is performed by an edge enabler client (EEC). The method includes:
Step 51, mutual identity authentication and/or establishment of a transport layer security (TLS) connection are/is executed between an EEC and an ECS based on a key K_{EEC-ECS}.

In an example, different types of keys, for example, Ks_NAF, Ks_int_NAF and Ks_ext_NAF, may be computed according to an NAF ID of the ECS. A terminal may select one of the keys as a K_{ECS}. The key K_{EEC-ECS} is determined based on the key K_{ECS} and an EEC identifier (ID). The mutual identity authentication and/or the establishment of the transport layer security (TLS) connection are/is executed between the EEC and the ECS based on the key K_{EEC-ECS}.

It should be noted that those skilled in the art can understand that the method according to the example of the disclosure can be executed separately, or can be executed along with some methods in the examples of the disclosure or some methods in the related art.

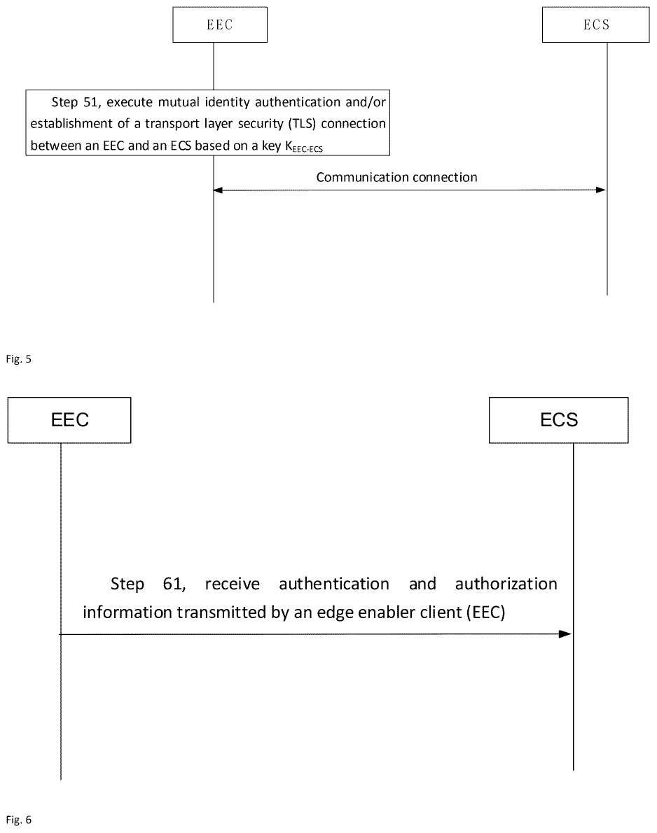

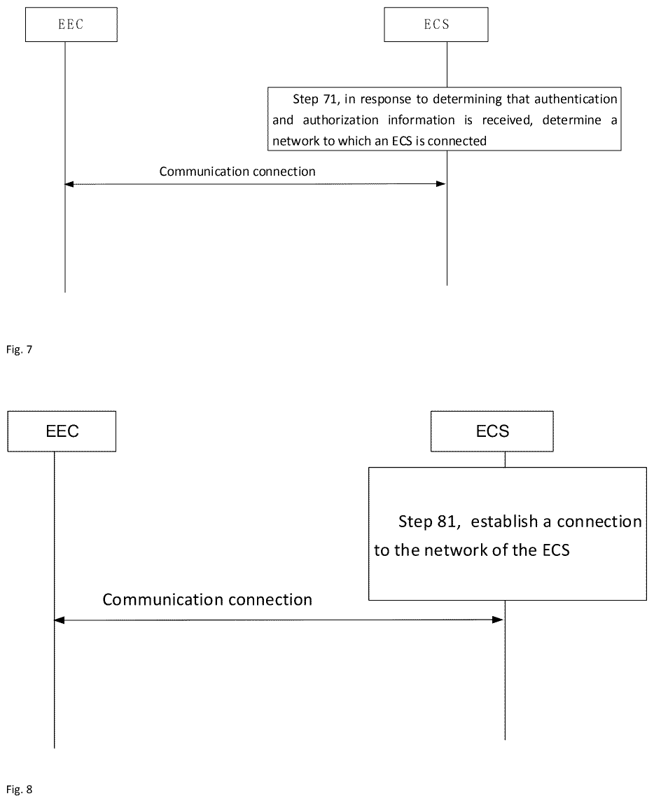

As shown in FIG. 6, yet another method for authentication and authorization is provided by this example. The method is performed by an edge configuration server (ECS). The method includes:
Step 61, authentication and authorization information transmitted by an edge enabler client (EEC) is received.

The authentication and authorization information is configured to request a token for service authorization.

Here, a terminal involved in the disclosure may be, but is not limited to, a mobile phone, a wearable device, a vehicle-mounted terminal, a road side unit (RSU), a smart home terminal, an industrial sensing device and/or a medical device. In some examples, the terminal may be a Redcap terminal or a new radio (NR) terminal of a predetermined version (for example, a NR terminal of R17). The terminal may be registered in a home network. The terminal may obtain a bootstrapping transaction identifier (B-TID) from a bootstrapping server function (BSF) of the home network of the EEC during running of a generic bootstrapping architecture (GBA). By treating the ECS as a network application function (NAF), different types of keys, for example, Ks_NAF, Ks_int_NAF and Ks_ext_NAF, may be computed according to an NAF ID of an EES. The terminal may select one of the keys as a K_{ECS}. In an example, the terminal may derive K_{EEC-ECS} based on the K_{ECS} and an EEC ID. The K_{EEC-ECS} may be derived by using a key derivation function (KDF). The EEC ID is used as an input parameter of the KDF and the K_{EES} is used as a key for deriving the K_{EEC-ECS}.

Here, the edge enabler client (EEC) may be an application, such as WeChat application and Weibo application, run on the terminal.

It should be noted that in the example of the disclosure, the EES is deployed in an operator domain and trusted by an operator. The EEC and the ECS may communicate with each other wirelessly based on a radio communication network. The radio communication network may be, but is not limited to, a 4G or 5G radio communication network, and may also be other evolved radio communication networks, which is not limited here.

In an example, the authentication and authorization information transmitted by the edge enabler client (EEC) is received. The authentication and authorization information is configured to request the token for the service authorization. The authentication and authorization information includes at least one of:
the bootstrapping transaction identifier (B-TID);
an encrypted EEC identifier (ID), where the encrypted EEC ID is encrypted based on the key K_{ECS};
a key type indicator; where the key type indicator may be a character string, for example, Ks_int_NAF, and is used as a key of the K_{EES};
a generic public subscription identifier (GPSI); and
a message authentication code.

It should be noted that the message authentication code is an MAC-I determined based on the K_{ECS}, and is configured to protect integrity of the B-TID, the encrypted EEC ID, the GPSI and/or the key type indicator.

In an example, the EEC may obtain the B-TID from the bootstrapping server function (BSF) of the home network of the EEC during the running of the generic bootstrapping architecture (GBA).

In an example, the token includes at least one piece of the following information:
a fully qualified domain name (FQDN) of the ECS;
the EEC identifier (ID);
a GPSI;
an expected EES service name;
an FQDN of the EES;
effective time; and
a digital signature.

In an example, the authentication and authorization information transmitted by the edge enabler client (EEC) is received. The authentication and authorization information is configured to request the token for the service authorization. In response to determining that the authentication and authorization information is received, a network to which the ECS is connected is determined.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. In response to determining that an identifier of the network to which the ECS is connected is identical to an identifier of a public land mobile network of the EEC that is configured to establish a connection to the ECS, and the identifier of the public land mobile network of the EEC that is configured to establish a connection to the ECS is different from a home network identifier of the EEC, a connection to the network to which the ECS is connected is established.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The identifier and/or an access type of the public land mobile network of the EEC that is configured to establish a connection to the ECS are/is obtained from a policy control function (PCF). In response to determining that the identifier of the network to which the ECS is connected is identical to the identifier of the public land mobile network of the EEC that is configured to establish a connection to the ECS, and the identifier of the public land mobile network of the EEC that is configured to establish a connection to the ECS is different from the home network identifier of the EEC, the connection to the network to which the ECS is connected is established.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The home network identifier of the EEC is determined based on the B-TID. In response to determining that the identifier of the network to which the ECS is connected is identical to the identifier of the public land mobile network of the EEC that is configured to establish a connection to the ECS, and the identifier of the public land mobile network of the EEC that is configured to establish a connection to the ECS is different from the home network identifier of the EEC, the connection to the network to which the ECS is connected is established.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. Application request information is transmitted to a Zn-Proxy in the home network of the EEC. The application request information includes at least one of: a B-TID received by the ECS; the network application function (NAF) identifier (NAF ID); and the key type indicator.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator. Application response information transmitted by the Zn-Proxy is received. The application response information includes the key K_{ECS} and/or effective time information of the key K_{ECS}.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator. The application response information transmitted by the Zn-Proxy is received. The application response information includes the key K_{ECS} and/or the effective time information of the key K_{ECS}. Integrity of the authentication and authorization information is verified based on the key K_{ECS} and/or the MAC-I.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator. The application response information transmitted by the Zn-Proxy is received. The application response information includes the key K_{ECS} and/or the effective time information of the key K_{ECS}. The MAC-I is generated based on the key K_{ECS} and the authentication and authorization information. The MAC-I is compared with an MAC-I of the authentication and authorization information. In response to determining that the MAC-I is consistent with the MAC-I of the authentication and authorization information, it is determined that the authentication and authorization information is not modified.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator. The application response information transmitted by the Zn-Proxy is received. The application response information includes the key K_{ECS} and/or the effective time information of the key K_{ECS}. The integrity of the authentication and authorization information is verified based on the key K_{ECS} and/or the MAC-I. In response to determining that the authentication and authorization information is modified, a configuration request process is terminated. Alternatively, in response to determining that the authentication and authorization information is not modified, the encrypted EEC ID received by the EES is decrypted.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator. The application response information transmitted by the Zn-Proxy is received. The application response information includes the key K_{ECS} and/or the effective time information of the key K_{ECS}. The integrity of the authentication and authorization information is verified based on the key K_{ECS} and/or the MAC-I. In response to determining that the authentication and authorization information is not modified, the encrypted EEC ID received by the ECS is decrypted. Based on the decrypted EEC ID, whether the EEC is authorized to execute a configuration request operation is determined according to a predetermined policy. In response to determining that the EEC is not authorized to execute the configuration request operation, the configuration request process is terminated. In response to determining that the EEC is authorized to execute the configuration request operation, the configuration request process continues.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator. The application response information transmitted by the Zn-Proxy is received. The application response information includes the key K_{ECS} and/or the effective time information of the key K_{ECS}. In response to determining that the K_{ECS} is received, the K_{EEC-ECS} is determined according to the K_{ECS} and the EEC ID. The key K_{EEC-ECS} is configured to execute mutual identity authentication and/or establishment of a transport layer security (TLS) connection between the EEC and the ECS.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator. The application response information transmitted by the Zn-Proxy is received. The application response information includes the key K_{ECS} and/or the effective time information of the key K_{ECS}. In response to determining that the K_{ECS} is received, the K_{EEC-ECS} is determined according to the K_{ECS} and the EEC ID. The key K_{EEC-ECS} is configured to execute the mutual identity authentication and/or the establishment of the transport layer security (TLS) connection between the EEC and the ECS. The mutual identity authentication between the EEC and the ECS and/or the establishment of the TLS connection between the EEC and the ECS are/is executed based on the key K_{EEC-ECS}.

In an example, the application response information transmitted by the Zn-Proxy is received. The application response information includes the key K_{ECS} and/or the effective time information of the key K_{ECS}. In response to determining that the K_{ECS} is received, the K_{EEC-ECS} is determined according to the K_{ECS} and the EEC ID. The key K_{EEC-ECS} is configured to execute the mutual identity authentication and/or the establishment of the transport layer security (TLS) connection between the EEC and the ECS. The mutual identity authentication between the EEC and the ECS and/or the establishment of the TLS connection between the EEC and the ECS are/is executed based on the key K_{EEC-ECS}. In response to determining that the mutual identity authentication succeeds and the TLS connection is established between the EEC and the ECS, the token for the EEC to request the service authorization is generated.

In an example, the application response information transmitted by the Zn-Proxy is received. The application response information includes the key K_{ECS} and/or the effective time information of the key K_{ECS}. In response to determining that the K_{ECS} is received, the K_{EEC-ECS} is determined according to the K_{ECS} and the EEC ID. The key K_{EEC-ECS} is configured to execute the mutual identity authentication and/or the establishment of the transport layer security (TLS) connection between the EEC and the ECS. The mutual identity authentication between the EEC and the ECS and/or the establishment of the TLS connection between the EEC and the ECS are/is executed based on the key K_{EEC-ECS}. In response to determining that the mutual identity authentication succeeds and the TLS connection is established between the EEC and the ECS, the token for the EEC to request the service authorization is generated. The token is transmitted to the EEC.

In an example, the application response information transmitted by the Zn-Proxy is received. The application response information includes the key K_{ECS} and/or the effective time information of the key K_{ECS}. In response to determining that the K_{ECS} is received, the K_{EEC-ECS} is determined according to the K_{ECS} and the EEC ID. The key K_{EEC-ECS} is configured to execute the mutual identity authentication and/or the establishment of the transport layer security (TLS) connection between the EEC and the ECS. The mutual identity authentication between the EEC and the ECS and/or the establishment of the TLS connection between the EEC and the ECS are/is executed based on the key K_{EEC-ECS}. In response to determining that the mutual identity authentication succeeds and the TLS connection is established between the EEC and the ECS, the token for the EEC to request the service authorization is generated. The token is transmitted to the EEC through the TLS connection.

In an example, the token includes at least one piece of the following information:
the fully qualified domain name (FQDN) of the ECS;
the EEC identifier (ID);
the GPSI;
the expected EES service name;
the FQDN of the EES;
the effective time; and
the digital signature.

It should be noted that those skilled in the art can understand that the method according to the example of the disclosure can be executed separately, or can be executed along with some methods in the examples of the disclosure or some methods in the related art.

As shown in FIG. 7, yet another method for authentication and authorization is provided by this example. The method is performed by an edge configuration server (ECS). The method includes:
Step 71, in response to determining that authentication and authorization information is received, a network to which the ECS is connected is determined.

In an example, the authentication and authorization information transmitted by an edge enabler client (EEC) is received. The authentication and authorization information is configured to request a token for service authorization. In response to determining that the authentication and authorization information is received, the network to which the ECS is connected is determined.

In an example, the authentication and authorization information transmitted by an edge enabler client (EEC) is received. The authentication and authorization information is configured to request the token for the service authorization. In response to determining that the authentication and authorization information is received, the network to which the ECS is connected is determined. In response to determining that an identifier of the network to which the ECS is connected is identical to an identifier of a public land mobile network of the EEC that is configured to establish a connection to the ECS, and the identifier of the public land mobile network of the EEC that is configured to establish a connection to the ECS is different from a home network identifier of the EEC, a connection to the network to which the ECS is connected is established.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The identifier and/or an access type of the public land mobile network of the EEC that is configured to establish a connection to the ECS are/is obtained from a policy control function (PCF) In response to determining that the identifier of the network to which the ECS is connected is identical to the identifier of the public land mobile network of the EEC that is configured to establish a connection to the ECS, and the identifier of the public land mobile network of the EEC that is configured to establish a connection to the ECS is different from the home network identifier of the EEC, the connection to the network to which the ECS is connected is established.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The home network identifier of the EEC is determined based on a B-TID. In response to determining that the identifier of the network to which the ECS is connected is identical to the identifier of the public land mobile network of the EEC that is configured to establish a connection to the ECS, and the identifier of the public land mobile network of the EEC that is configured to establish a connection to the ECS is different from the home network identifier of the EEC, the connection to the network to which the ECS is connected is established.

It should be noted that those skilled in the art can understand that the method according to the example of the disclosure can be executed separately, or can be executed along with some methods in the examples of the disclosure or some methods in the related art.

As shown in FIG. 8, yet another method for authentication and authorization is provided by this example. The method is performed by an edge configuration server (ECS). The method includes:
Step 81, in response to determining that an identifier of a network to which the ECS is connected is identical to an identifier of a public land mobile network of an EEC that is configured to establish a connection to the ECS, and the identifier of the public land mobile network of the EEC that is configured to establish a connection to the ECS is different from a home network identifier of the EEC, a connection to the network to which the ECS is connected is established.

In an example, authentication and authorization information transmitted by the edge enabler client (EEC) is received. The authentication and authorization information is configured to request a token for service authorization. In response to determining that the authentication and authorization information is received, the network to which the ECS is connected is determined. In response to determining that the identifier of the network to which the ECS is connected is identical to the identifier of the public land mobile network of the EEC that is configured to establish a connection to the ECS, and the identifier of the public land mobile network of the EEC that is configured to establish a connection to the ECS is different from the home network identifier of the EEC, the connection to the network to which the ECS is connected is established.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The identifier and/or an access type of the public land mobile network of the EEC that is configured to establish a connection to the ECS are/is obtained from a policy control function (PCF) In response to determining that the identifier of the network to which the ECS is connected is identical to the identifier of the public land mobile network of the EEC that is configured to establish a connection to the ECS, and the identifier of the public land mobile network of the EEC that is configured to establish a connection to the ECS is different from the home network identifier of the EEC, the connection to the network to which the ECS is connected is established.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The home network identifier of the EEC is determined based on a B-TID. In response to determining that the identifier of the network to which the ECS is connected is identical to the identifier of the public land mobile network of the EEC that is configured to establish a connection to the ECS, and the identifier of the public land mobile network of the EEC that is configured to establish a connection to the ECS is different from the home network identifier of the EEC, the connection to the network to which the ECS is connected is established.

It should be noted that those skilled in the art can understand that the method according to the example of the disclosure can be executed separately, or can be executed along with some methods in the examples of the disclosure or some methods in the related art.

As shown in FIG. 9, yet another method for authentication and authorization is provided by this example. The method is performed by an edge configuration server (ECS). The method includes:
Step 91, application request information is transmitted to a Zn-Proxy in a home network of an EEC.

The application request information includes at least one of:
a B-TID received by the ECS;
a network application function (NAF) identifier (ID); and
a key type indicator.

In an example, authentication and authorization information transmitted by the edge enabler client (EEC) is received. The authentication and authorization information is configured to request a token for service authorization. In response to determining that the authentication and authorization information is received, a network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator. Application response information transmitted by the Zn-Proxy is received. The application response information includes a key K_{ECS} and/or effective time information of the key K_{ECS}.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator. The application response information transmitted by the Zn-Proxy is received. The application response information includes the key K_{ECS} and/or the effective time information of the key K_{ECS}. Integrity of the authentication and authorization information is verified based on the key K_{ECS} and/or an MAC-I.

It should be noted that those skilled in the art can understand that the method according to the example of the disclosure can be executed separately, or can be executed along with some methods in the examples of the disclosure or some methods in the related art.

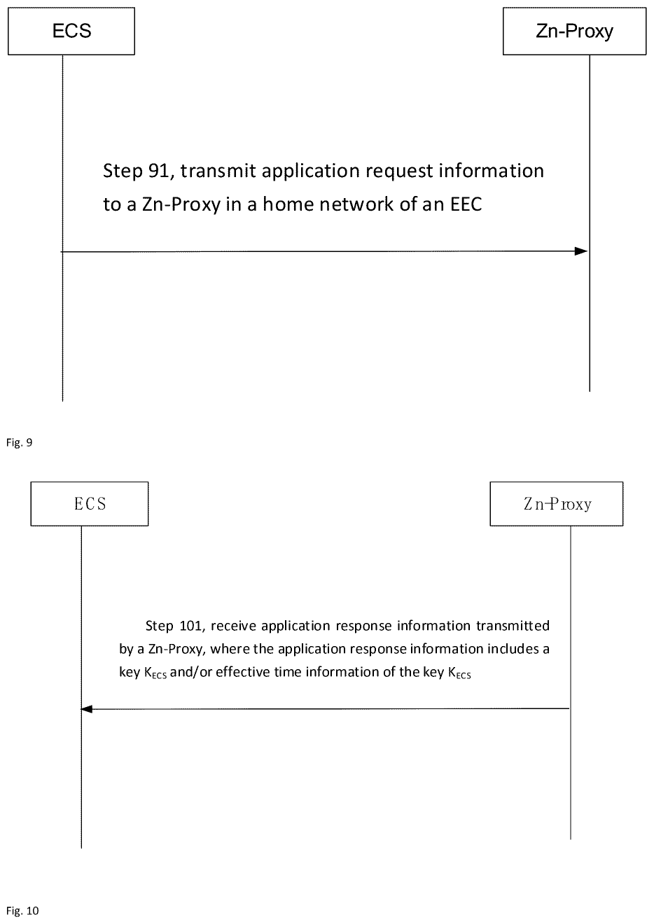

As shown in FIG. 10, yet another method for authentication and authorization is provided by this example. The method is performed by an edge configuration server (ECS). The method includes:
Step 101, application response information transmitted by a Zn-Proxy is received. The application response information includes a key K_{ECS} and/or effective time information of the key K_{ECS}.

In an example, authentication and authorization information transmitted by an edge enabler client (EEC) is received. The authentication and authorization information is configured to request a token for service authorization. In response to determining that the authentication and authorization information is received, a network to which the ECS is connected is determined. Application request information is transmitted to a Zn-Proxy in a home network of the EEC. The application request information includes at least one of: a B-TID received by the ECS; a network application function (NAF) identifier (NAF ID); and a key type indicator. The application response information transmitted by the Zn-Proxy is received. The application response information includes the key K_{ECS} and/or the effective time information of the key K_{ECS}.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator. The application response information transmitted by the Zn-Proxy is received. The application response information includes the key K_{ECS} and/or the effective time information of the key K_{ECS}. Integrity of the authentication and authorization information is verified based on the key K_{ECS} and/or an MAC-I.

It should be noted that those skilled in the art can understand that the method according to the example of the disclosure can be executed separately, or can be executed along with some methods in the examples of the disclosure or some methods in the related art.

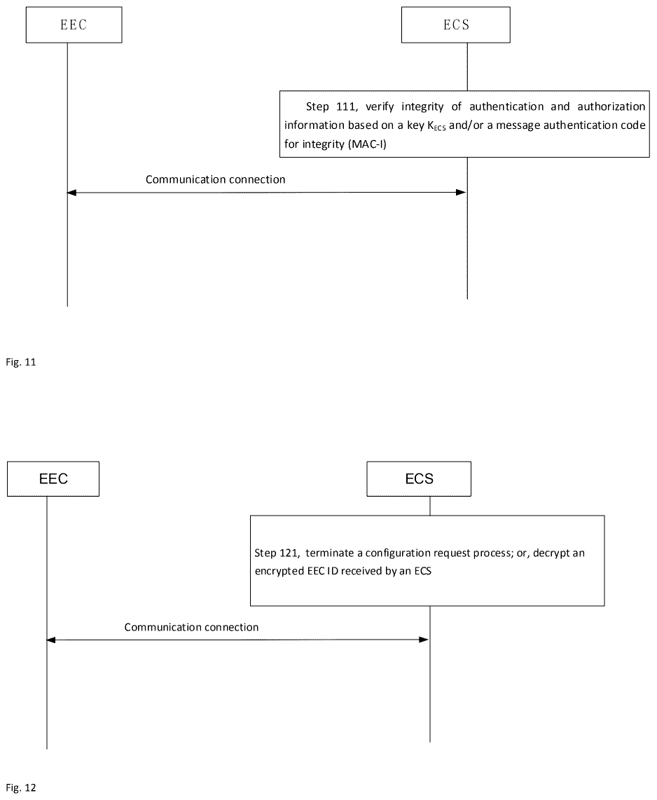

As shown in FIG. 11, yet another method for authentication and authorization is provided by this example. The method is performed by an edge configuration server (ECS). The method includes:
Step 111, integrity of authentication and authorization information is verified based on a key K_{ECS}/or an MAC-I.

In an example, the authentication and authorization information transmitted by an edge enabler client (EEC) is received. The authentication and authorization information is configured to request a token for service authorization. In response to determining that the authentication and authorization information is received, a network to which the ECS is connected is determined. Application request information is transmitted to a Zn-Proxy in a home network of the EEC. The application request information includes at least one of: a B-TID received by the ECS; a network application function (NAF) identifier (NAF ID); and a key type indicator. Application response information transmitted by the Zn-Proxy is received. The application response information includes the key K_{ECS} and/or effective time information of the key K_{ECS}. The integrity of the authentication and authorization information is verified based on the key K_{ECS} and/or the MAC-I.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator. The application response information transmitted by the Zn-Proxy is received. The application response information includes the key K_{ECS} and/or the effective time information of the key K_{ECS}. The MAC-I is generated based on the key K_{ECS} and the authentication and authorization information. The MAC-I is compared with an MAC-I of the authentication and authorization information. In response to determining that the MAC-I is consistent with the MAC-I of the authentication and authorization information, it is determined that the authentication and authorization information is not modified. Alternatively, in response to determining that the MAC-I is inconsistent with the MAC-I of the authentication and authorization information, it is determined that the authentication and authorization information is modified.

It should be noted that those skilled in the art can understand that the method according to the example of the disclosure can be executed separately, or can be executed along with some methods in the examples of the disclosure or some methods in the related art.

As shown in FIG. 12, yet another method for authentication and authorization is provided by this example. The method is performed by an edge configuration server (ECS). The method includes:
Step 121, in response to determining that authentication and authorization information is modified, a request process is terminated.

Alternatively,
in response to determining that authentication and authorization information is not modified, an encrypted EEC ID received by the ECS is decrypted.

In an example, the authentication and authorization information transmitted by an edge enabler client (EEC) is received. The authentication and authorization information is configured to request a token for service authorization. In response to determining that the authentication and authorization information is received, a network to which the ECS is connected is determined. Application request information is transmitted to a Zn-Proxy in a home network of the EEC. The application request information includes at least one of: a B-TID received by the ECS; a network application function (NAF) identifier (NAF ID); and a key type indicator. Application response information transmitted by the Zn-Proxy is received. The application response information includes a key K_{ECS} and/or effective time information of the key K_{ECS}. Integrity of the authentication and authorization information is verified based on the key K_{ECS} and/or an MAC-I. In response to determining that the authentication and authorization information is modified, a configuration request process is terminated. Alternatively, in response to determining that the authentication and authorization information is not modified, the encrypted EEC ID received by the EES is decrypted.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator. The application response information transmitted by the Zn-Proxy is received. The application response information includes the key K_{ECS} and/or the effective time information of the key K_{ECS}. The MAC-I is generated based on the key K_{ECS} and the authentication and authorization information. The MAC-I is compared with an MAC-I of the authentication and authorization information. In response to determining that the MAC-I is consistent with the MAC-I of the authentication and authorization information, it is determined that the authentication and authorization information is not modified. Alternatively, in response to determining that the MAC-I is inconsistent with the MAC-I of the authentication and authorization information, it is determined that the authentication and authorization information is modified. In response to determining that the authentication and authorization information is modified, the configuration request process is terminated. Alternatively, in response to determining that the authentication and authorization information is not modified, the encrypted EEC ID received by the EES is decrypted.

It should be noted that those skilled in the art can understand that the method according to the example of the disclosure can be executed separately, or can be executed along with some methods in the examples of the disclosure or some methods in the related art.

As shown in FIG. 13, yet another method for authentication and authorization is provided by this example. The method is performed by an edge configuration server (ECS). The method includes:
Step 131, based on a decrypted EEC ID, whether an EEC is authorized to execute a configuration request operation according to a predetermined policy is determined.
Step 132, in response to determining that the EEC is not authorized to execute the configuration request operation, a configuration request process is terminated.

In an example, authentication and authorization information transmitted by the edge enabler client (EEC) is received. The authentication and authorization information is configured to request a token for service authorization. In response to determining that the authentication and authorization information is received, a network to which the ECS is connected is determined. Application request information is transmitted to a Zn-Proxy in a home network of the EEC. The application request information includes at least one of: a B-TID received by the ECS; a network application function (NAF) identifier (NAF ID); and a key type indicator. Application response information transmitted by the Zn-Proxy is received. The application response information includes a key K_{ECS} and/or effective time information of the key K_{ECS}. Integrity of the authentication and authorization information is verified based on the key K_{ECS} and/or an MAC-I. In response to determining that the authentication and authorization information is not modified, an encrypted EEC ID received by the ECS is decrypted. Based on the decrypted EEC ID, whether the EEC is authorized to execute the configuration request operation is determined according to the predetermined policy. In response to determining that the EEC is not authorized to execute the configuration request operation, the configuration request process is terminated. Alternatively, in response to determining that the EEC is authorized to execute the configuration request operation, the configuration request process continues.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator. The application response information transmitted by the Zn-Proxy is received. The application response information includes the key K_{ECS} and/or the effective time information of the key K_{ECS}. The MAC-I is generated based on the key K_{ECS} and the authentication and authorization information. The MAC-I is compared with an MAC-I of the authentication and authorization information. In response to determining that the MAC-I is consistent with the MAC-I of the authentication and authorization information, it is determined that the authentication and authorization information is not modified. Alternatively, in response to determining that the MAC-I is inconsistent with the MAC-I of the authentication and authorization information, it is determined that the authentication and authorization information is modified. In response to determining that the authentication and authorization information is not modified, the encrypted EEC ID received by the ECS is decrypted. In response to determining that the EEC is not authorized to execute the configuration request operation, the configuration request process is terminated. Alternatively, in response to determining that the EEC is authorized to execute the configuration request operation, the configuration request process continues.

It should be noted that those skilled in the art can understand that the method according to the example of the disclosure can be executed separately, or can be executed along with some methods in the examples of the disclosure or some methods in the related art.

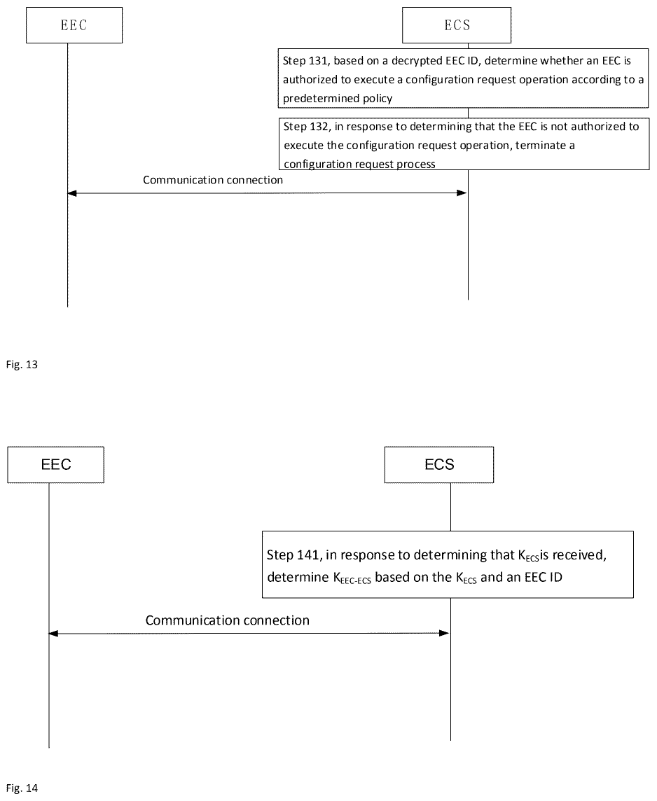

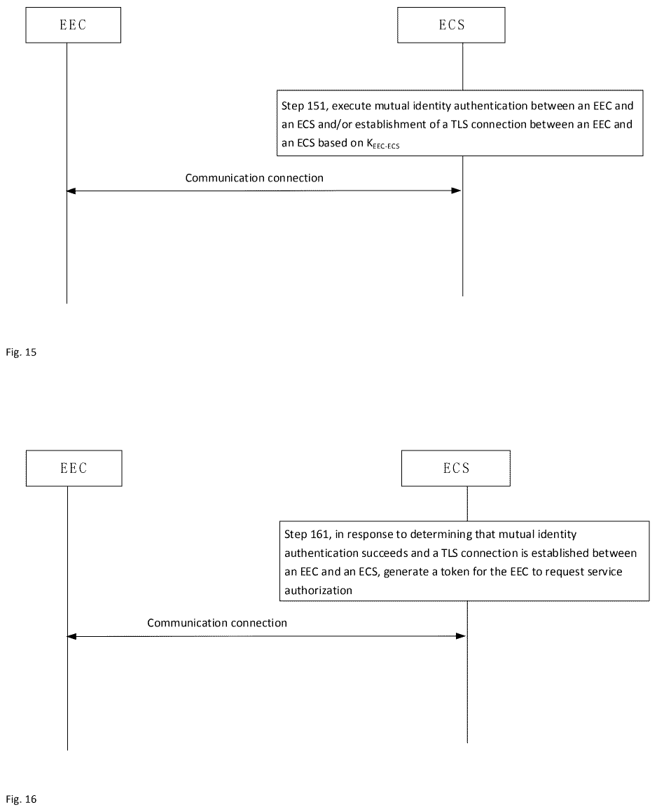

As shown in FIG. 14, yet another method for authentication and authorization is provided by this example. The method is performed by an edge configuration server (ECS). The method includes:
Step 141, in response to determining that K_{ECS} is received, K_{EEC-ECS} is determined according to the K_{ECS} and an EEC ID. The key K_{EEC-ECS} is configured to execute mutual identity authentication and/or establishment of a transport layer security (TLS) connection between an EEC and the ECS.

In an example, authentication and authorization information transmitted by the edge enabler client (EEC) is received. The authentication and authorization information is configured to request a token for service authorization. In response to determining that the authentication and authorization information is received, a network to which the ECS is connected is determined. The application request information is transmitted to a Zn-Proxy in a home network of the EEC. The application request information includes at least one of: a B-TID received by the ECS; a network application function (NAF) identifier (NAF ID); and a key type indicator. Application response information transmitted by the Zn-Proxy is received. The application response information includes the key K_{ECS} and/or effective time information of the key K_{ECS}. In response to determining that the K_{ECS} is received, the K_{EEC-ECS} is determined according to the K_{ECS} and the EEC ID. The key K_{EEC-ECS} is configured to execute the mutual identity authentication and/or the establishment of the transport layer security (TLS) connection between the EEC and the ECS.

In an example, the authentication and authorization information transmitted by the edge enabler client (EEC) is received. The authentication and authorization information is configured to request the token for the service authorization. In response to determining that the authentication and authorization information is received, the network to which the ECS is connected is determined. The application request information is transmitted to the Zn-Proxy in the home network of the EEC. The application request information includes at least one of: the B-TID received by the ECS; the network application function (NAF) identifier (NAF ID); and the key type indicator. The application response information transmitted by the Zn-Proxy is received. The application response information includes the key K_{ECS} and/or effective time information of the key K_{ECS}. In response to determining that the K_{ECS} is received, the K_{EEC-ECS} is determined according to the K_{ECS} and the EEC ID. The key K_{EEC-ECS} is configured to execute the mutual identity authentication and/or the establishment of the transport layer security (TLS) connection between the EEC and the ECS. The mutual identity authentication between the EEC and the ECS and/or the establishment of the TLS connection between the EEC and the ECS are/is executed based on the key K_{EEC-ECS}.

It should be noted that those skilled in the art can understand that the method according to the example of the disclosure can be executed separately, or can be executed along with some methods in the examples of the disclosure or some methods in the related art.

As shown in FIG. 15, yet another method for authentication and authorization is provided by this example. The method is performed by an edge configuration server (ECS). The method includes:
Step 151, mutual identity authentication between an EEC and the ECS and/or establishment of a TLS connection between the EEC and the ECS are/is executed based on K_{EEC-ECS}.

In an example, authentication and authorization information transmitted by the edge enabler client (EEC) is received. The authentication and authorization information is configured to request a token for service authorization. In response to determining that the authentication and authorization information is received, a network to which the ECS is connected is determined. Application request information is transmitted to a Zn-Proxy in a home network of the EEC. The application request information includes at least one of: a B-TID received by the ECS; a network application function (NAF) identifier (NAF ID); and a key type indicator. Application response information transmitted by the Zn-Proxy is received. The application response information includes a key K_{ECS} and/or effective time information of the key K_{ECS}. In response to determining that the K_{ECS} is received, the K_{EEC-ECS} is determined according to the K_{ECS} and an EEC ID. The key K_{EEC-ECS} is configured to execute the mutual identity authentication and/or the establishment of the transport layer security (TLS) connection between the EEC and the ECS. The mutual identity authentication between the EEC and the ECS and/or the establishment of the TLS connection between the EEC and the ECS are/is executed based on the key K_{EEC-ECS}.

It should be noted that those skilled in the art can understand that the method according to the example of the disclosure can be executed separately, or can be executed along with some methods in the examples of the disclosure or some methods in the related art.

As shown in FIG. 16, yet another method for authentication and authorization is provided by this example. The method is performed by an edge configuration server (ECS). The method includes:
Step 161, in response to determining that mutual identity authentication succeeds and a TLS connection is established between an EEC and the ECS, a token for the EEC to request service authorization is generated.

In an example, authentication and authorization information transmitted by the edge enabler client (EEC) is received. The authentication and authorization information is configured to request the token for the service authorization. In response to determining that the authentication and authorization information is received, a network to which the ECS is connected is determined. Application request information is transmitted to a Zn-Proxy in a home network of the EEC. The application request information includes at least one of: a B-TID received by the ECS; a network application function (NAF) identifier (NAF ID); and a key type indicator. Application response information transmitted by the Zn-Proxy is received. The application response information includes a key K_{ECS} and/or effective time information of the key K_{ECS}. In response to determining that the K_{ECS} is received, K_{EEC-ECS} is determined according to the K_{ECS} and an EEC ID. The key K_{EEC-ECS} is configured to execute the mutual identity authentication and/or the establishment of the transport layer security (TLS) connection between the EEC and the ECS. The mutual identity authentication between the EEC and the ECS and/or the establishment of the TLS connection between the EEC and the ECS are/is executed based on the key K_{EEC-ECS}. In response to determining that the mutual identity authentication succeeds and the TLS connection is established between the EEC and the ECS, the token for the EEC to request the service authorization is generated.

The token includes at least one piece of the following information:
a fully qualified domain name (FQDN) of the ECS;
the EEC identifier (ID);
a GPSI;
an expected EES service name;
an FQDN of an EES;
effective time; and
a digital signature.

It should be noted that those skilled in the art can understand that the method according to the example of the disclosure can be executed separately, or can be executed along with some methods in the examples of the disclosure or some methods in the related art.

As shown in FIG. 17, yet another method for authentication and authorization is provided by this example. The method is performed by an edge configuration server (ECS). The method includes:
Step 171, a token is transmitted to an EEC.

In an example, authentication and authorization information transmitted by the edge enabler client (EEC) is received. The authentication and authorization information is configured to request the token for service authorization. In response to determining that the authentication and authorization information is received, a network to which the ECS is connected is determined. Application request information is transmitted to a Zn-Proxy in a home network of the EEC. The application request information includes at least one of: a B-TID received by the ECS; a network application function (NAF) identifier (NAF ID); and a key type indicator. Application response information transmitted by the Zn-Proxy is received. The application response information includes a key K_{ECS} and/or effective time information of the key K_{ECS}. In response to determining that the K_{ECS} is received, K_{EEC-ECS} is determined according to the K_{ECS} and an EEC ID. The key K_{EEC-ECS} is configured to execute mutual identity authentication and/or establishment of a transport layer security (TLS) connection between the EEC and the ECS. The mutual identity authentication between the EEC and the ECS and/or the establishment of the TLS connection between the EEC and the ECS are/is executed based on the key K_{EEC-ECS}. In response to determining that the mutual identity authentication succeeds and the TLS connection is established between the EEC and the ECS, the token for the EEC to request the service authorization is generated. The token is transmitted to the EEC. Here, the token is transmitted to the EEC through the TLS connection.

The token includes at least one piece of the following information:
a fully qualified domain name (FQDN) of the ECS;
the EEC identifier (ID);
a GPSI;
an expected EES service name;
an FQDN of an EES;
effective time; and
a digital signature.

It should be noted that those skilled in the art can understand that the method according to the example of the disclosure can be executed separately, or can be executed along with some methods in the examples of the disclosure or some methods in the related art.

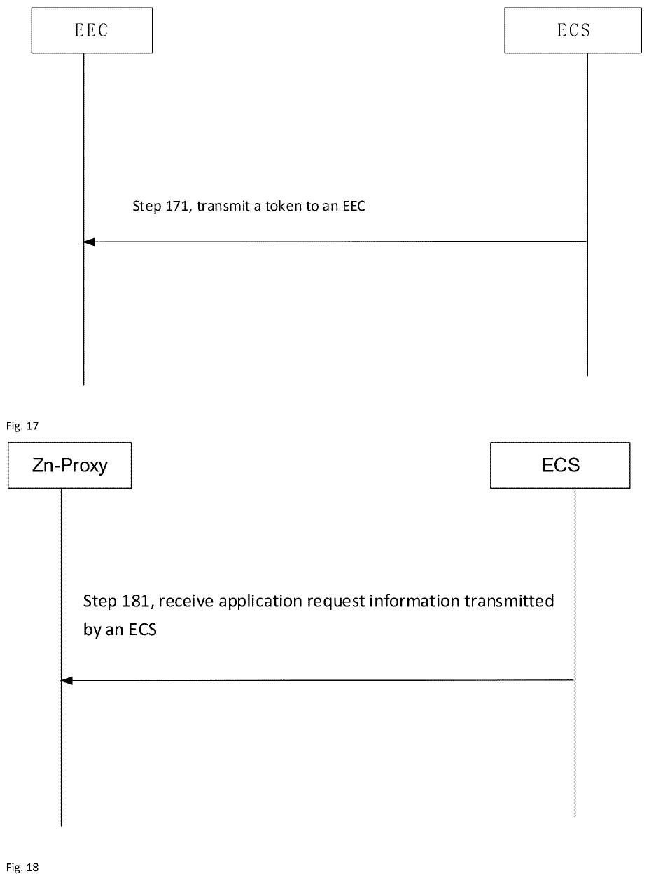

As shown in FIG. 18, yet another method for authentication and authorization is provided by this example. The method is performed by a Zn interface proxy Zn-Proxy. The method includes:
Step 181, application request information transmitted by an ECS is received.

The application request information includes at least one of:
a B-TID received by the ECS;
a network application function (NAF) identifier (ID); and
a key type indicator.

In an example, the application request information transmitted by the ECS is received. The application request information is transmitted to a bootstrapping server function (BSF) in a home network of an EEC. Application response information transmitted by the BSF is received. The application response information includes a key K_{ECS} and/or effective time information of the key K_{ECS}. The key K_{ECS} and/or the effective time information of the key K_{ECS} are/is transmitted to the ECS.

It should be noted that those skilled in the art can understand that the method according to the example of the disclosure can be executed separately, or can be executed along with some methods in the examples of the disclosure or some methods in the related art.

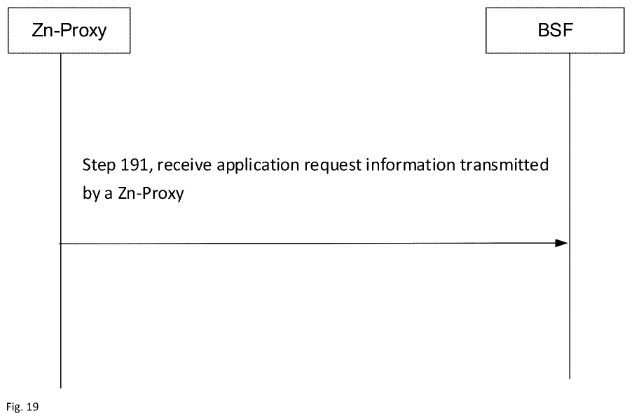

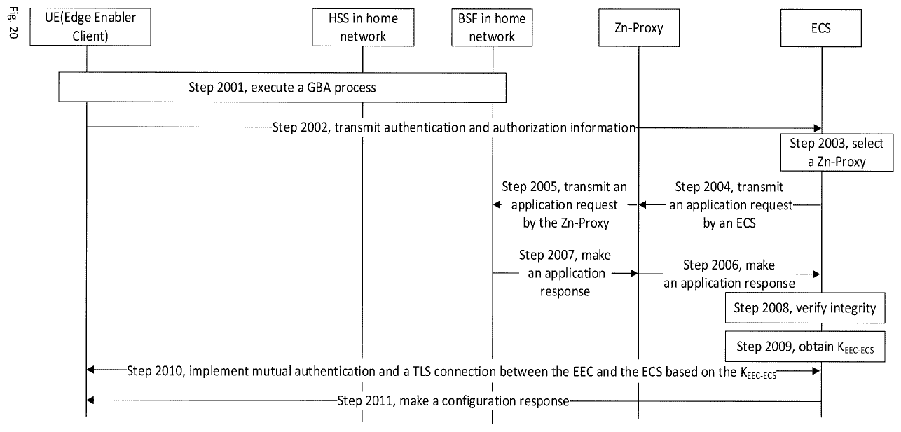

As shown in FIG. 19, still another method for authentication and authorization is provided by this example. The method is performed by a bootstrapping server function (BSF). The method includes:
Step 191, application request information transmitted by a Zn-Proxy is received.

The application request information includes at least one of:
a B-TID received by an ECS;
a network application function (NAF) identifier (ID); and
a key type indicator.

In an example, the application request information transmitted by the Zn-Proxy is received. A key K_{ECS} is determined based on the application request information. Application response information is transmitted to the Zn-Proxy. The application response information includes the key K_{ECS} and/or effective time information of the key K_{ECS}.

It should be noted that those skilled in the art can understand that the method according to the example of the disclosure can be executed separately, or can be executed along with some methods in the examples of the disclosure or some methods in the related art.

In order to better understand the example of the disclosure, the technical solution of the disclosure will be further described through an example:

### Instance 1

With reference to FIG. 20, still another method for authentication and authorization according to this example includes:
Step 2001, a generic bootstrapping architecture (GBA) process is executed. UE is registered in a home network. The UE obtains a B-TID from a BSF in the home network in the GBA process. By regarding an ECS as an NAF, Ks_NAF, Ks_int_NAF and Ks_ext_NAF may be computed by the UE according to an NAF ID of the ECS. The UE selects one of the items as K_{ECS}. The UE may derive K_{EEC-ECS} based on the K_{ECS} and an EEC ID. The K_{EEC-ECS} may be derived using a KDF defined in Appendix B of TS 33.220. The EEC ID is used as an input parameter and the K_{ECS} is used as the key for deriving the K_{EEC-ECS}.
Step 2002, authentication and authorization information is transmitted. An EEC transmits the authentication and authorization information to the ECS. The authentication and authorization information includes a B-TID, an encrypted EEC ID and a key type indicator. The EEC is encrypted with the K_{ECS}. The key type indicator is a character string (for example, “Ks_int_NAF”), and is used as a key of the K_{ECS}. The EEC may also transmit a GPSI to the ECS through the authentication and authorization information. An MAC-I is a message authentication code and is configured to protect integrity of the B-TID, the encrypted EEC ID, the GPSI (if provided) and the key type indicator.
Step 2003, a Zn-Proxy is selected. After receiving the request information, an EES detects the home network of the UE according to the B-TID. If a public land mobile network (PLMN) of the EES is different from a home PLMN of the UE, the EES needs to be connected to the Zn-Proxy in its own PLMN.
Step 2004, an application request is transmitted by the ECS. The ECS needs to transmit the application request to the Zn-Proxy. The application request includes the B-TID, the NAF ID and a key indicator of the ECS.
Step 2005, the Zn-Proxy transmits the application request. The Zn-Proxy transmits the application request to the BSF in the home network of the UE. The application request includes the B-TID, the NAF ID and the key indicator of the ECS.
Step 2006, an application response is made. The BSF derives the K_{ECS} according to the B-TID, the NAF ID and the key indicator of the ECS. The BSF transmits the K_{ECS} and a corresponding expiration to the Zn-Proxy.
Step 2007, an application response is made. The Zn-Proxy transmits the K_{ECS} and the K_{ECS} expiration to the ECS.
Step 2008, integrity is verified. The ECS verifies the integrity of the authentication and authorization information by using the K_{ECS} and the MAC-I. If the authentication and authorization information is modified, the ECS terminates a supply request process. Otherwise, the EES decrypts the EEC ID. The ECS checks whether the EEC is authorized to execute a configuration request operation according to a pre-configured policy. If the EEC is authorized, the process proceeds to step 2009. Otherwise, the ECS terminates the supply request process.
Step 2009, the K_{EEC-ECS} is obtained. After the K_{ECS} is received, the ECS derives the K_{EEC-ECS} according to the K_{ECS} and the EEC ID. The K_{EEC-ECS} may be derived using a KDF defined in Appendix B of TS 33.220. The EEC ID is used as an input parameter and the K_{ECS} is used as the key for deriving the K_{EEC-ECS}.
Step 2010, authentication of the EEC ID and a TLS connection are implemented based on the K_{EEC-ECS}. The K_{EEC-ECS} is used as a key of the NAF. A GPSI of the UE may be further verified by the ECS through an identifier application programming interface (API) of the UE.
Step 2011, a configuration response is made. After the EEC ID is authenticated and the TLS connection is established, the token is generated for the EEC by the ECS. The token is transmitted to the UE through security TLS. In consideration of that the EEC ID and the GPSI of the UE are successfully authenticated by the ECS, the EES service token may include an ECS FQDN (publisher), the EEC ID (subject), the GPSI (subject), an expected EES service name (scope), an EES FQDN (audience), expiration, and a digital signature generated by the ECS.

As shown in FIG. 21, an apparatus for authentication and authorization is provided by this example. The apparatus includes:
a transmission module 211 configured to transmit authentication and authorization information to an edge configuration server (ECS); where
the authentication and authorization information is configured to request a token for service authorization.

It should be noted that those skilled in the art can understand that the method according to the example of the disclosure can be executed separately, or can be executed along with some methods in the examples of the disclosure or some methods in the related art.

As shown in FIG. 22, another apparatus for authentication and authorization is provided by this example. The apparatus includes:
a reception module 221 configured to receive authentication and authorization information transmitted by an edge enabler client (EEC); where
the authentication and authorization information is configured to request a token for service authorization.

It should be noted that those skilled in the art can understand that the method according to the example of the disclosure can be executed separately, or can be executed along with some methods in the examples of the disclosure or some methods in the related art.

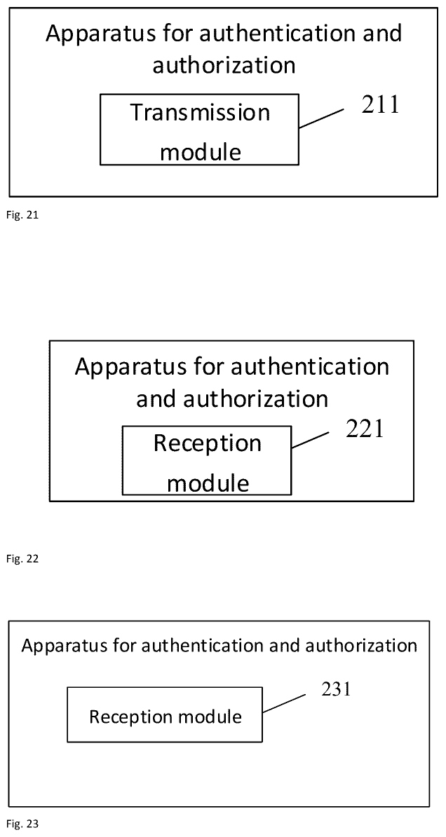

As shown in FIG. 23, yet another apparatus for authentication and authorization is provided by this example. The apparatus includes:
a reception module 231 configured to receive application request information transmitted by an ECS; where
the application request information includes at least one of:
a B-TID received by the ECS;
a network application function (NAF) identifier (ID); and
a key type indicator.

It should be noted that those skilled in the art can understand that the method according to the example of the disclosure can be executed separately, or can be executed along with some methods in the examples of the disclosure or some methods in the related art.

As shown in FIG. 24, still another apparatus for authentication and authorization is provided by this example. The apparatus includes:
a reception module 241 configured to receive application request information transmitted by a Zn-Proxy; where
the application request information includes at least one of:
a B-TID received by an ECS;
a network application function (NAF) identifier (ID); and
a key type indicator.

It should be noted that those skilled in the art can understand that the method according to the example of the disclosure can be executed separately, or can be executed along with some methods in the examples of the disclosure or some methods in the related art.

The example of the disclosure provides a communication device. The communication device includes:
a processor; and
a memory configured to store a processor-executable instruction, where
the processor is configured to implement the method according to any example of the disclosure when running the executable instruction.

The processor may include various storage media, and the storage media are non-transitory computer storage media, and may continue storing information stored on the communication device after a power failure of the communication device.

The processor may be connected to the memory through a bus, etc. for reading an executable program stored on the memory.

A computer storage medium is further provided by the example of the disclosure. The computer storage medium stores a computer-executable program. The executable program implements the method according to any example of the disclosure when executed by a processor.

With respect to the apparatus in the above example, specific ways in which the modules execute operations have been described in detail in the examples relating to the method, and will not be described in detail here.

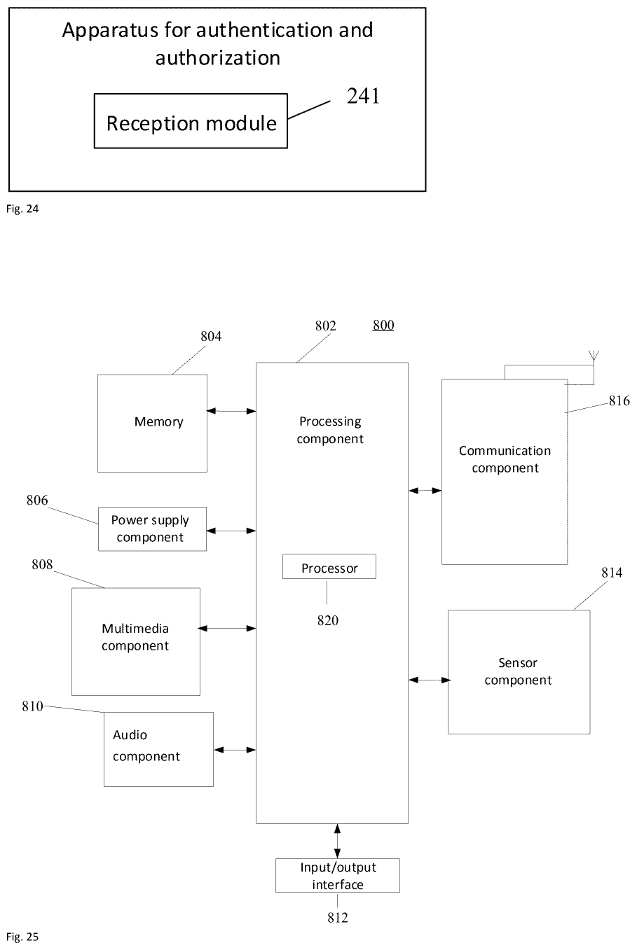

As shown in FIG. 25, a structure of a terminal is shown according to an example of the disclosure.

With reference to FIG. 25, the terminal 800 is shown. The terminal 800 is provided by this example. The terminal may be specifically a mobile phone, a computer, a digital broadcast terminal, a message receiving and transmitting device, a game console, a tablet device, a medical device, a fitness device, a personal digital assistant, etc.

With reference to FIG. 25, the terminal 800 may include one or more of a processing component 802, a memory 804, a power supply component 806, a multimedia component 808, an audio component 810, an input/output (I/O) interface 812, a sensor component 814, and a communication component 816.

Generally, the processing component 802 controls an overall operation of the terminal 800, such as an operation associated with display, a telephone call, data communication, a camera operation, and a recording operation. The processing component 802 may include one or more processors 820 for executing an instruction, and completing all or some steps of the method described above. In addition, the processing component 802 may include one or more modules for interaction between the processing component 802 and other components. For example, the processing component 802 may include a multimedia module for interaction between the multimedia component 808 and the processing component 802.

The memory 804 is configured to store various types of data to support the operation by the terminal 800. Instances of these data include instructions, contact data, phonebook data, messages, pictures, video, etc. of any application or method operated on the terminal 800. The memory 804 may be implemented by any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk and an optical disk.

The power supply component 806 energizes various components of the terminal 800. The power supply component 806 may include a power management system, one or more power supplies, and other components associated with power generation, management, and distribution for the terminal 800.

The multimedia component 808 includes a screen that provides an output interface between the terminal 800 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, swipe, and gestures on the touch panel. The touch sensor may not merely sense a boundary of a touch or swipe action, but also measure time of duration and a pressure associated with the touch or swipe action. In some examples, the multimedia component 808 includes a front-facing camera and/or a rear-facing camera. When the device 800 is in an operational mode, for example, a photographing mode or a video mode, the front-facing camera and/or the rear-facing camera may receive external multimedia data. Each of the front-facing camera and the rear-facing camera may be a fixed-focus optical lens system or have a focal length and an optical zoom capacity.

The audio component 810 is configured to output and/or input an audio signal. For example, the audio component 810 includes a microphone (MIC). The microphone is configured to receive an external audio signal when the terminal 800 is in an operational mode, such as a call mode, a recording mode or a speech identification mode. The audio signal received may be further stored in the memory 804 or transmitted through the communication component 816. In some examples, the audio component 810 further includes a speaker configured to output the audio signal.

The I/O interface 812 provides an interface between the processing component 802 and a peripheral interface module. The peripheral interface module may be a keyboard, a click wheel, a button, etc. These buttons may include, but are not limited to: a home button, a volume button, a start button and a lock button.

The sensor component 814 includes one or more sensors for providing state assessments in various aspects for the terminal 800. For example, the sensor component 814 may detect an on/off state of the device 800, and relative positioning of components. For example, the components are a display and a keypad of the terminal 800. The sensor component 814 may also detect positional change of the terminal 800 or a component of the terminal 800, presence or absence of contact between the user and the terminal 800, orientation or acceleration/deceleration of the terminal 800, and temperature change of the terminal 800. The sensor component 814 may include a proximity sensor configured to detect the presence of a nearby object in the absence of any physical touch. The sensor component 814 may further include an optical sensor, such as a complementary metal-oxide-semiconductor transistor (CMOS) or charge-coupled device (CCD) image sensor for use in an imaging application. In some examples, the sensor component 814 may further include an acceleration sensor, a gyroscope sensor, a magnetic sensor, a pressure sensor or a temperature sensor.

The communication component 816 is configured to facilitate wired or wireless communication between the terminal 800 and other devices. The terminal 800 may access a radio network, such as WiFi, 2G or 3G, or their combinations, based on a communication standard. In an example, the communication component 816 receives a broadcast signal or broadcast related information from an external broadcast management system via a broadcast channel. In an example, the communication component 816 further includes a near field communication (NFC) module to promote short-range communications. For example, the NFC module may be implemented based on a radio-frequency identification (RFID) technology, an infrared data association (IrDA) technology, an ultra-wide band (UWB) technology, a Bluetooth (BT) technology, and other technologies.

In an example, the terminal 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components for executing the method.

In an example, further provided is a non-transitory computer-readable storage medium including an instruction, for example, a memory 804 including an instruction. The instruction described above may be executed by the processor 820 of the terminal 800, so as to implement the method described above. For example, the non-transitory computer-readable storage medium may be a ROM, a random access memory (RAM), a CD-ROM, a magnetic tape, a floppy disc, an optical data storage device, etc.

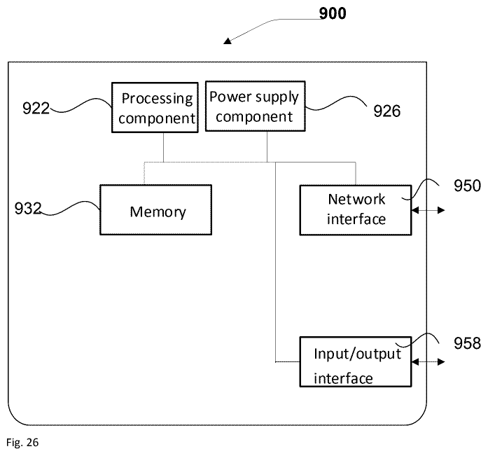

As shown in FIG. 26, a structure of a base station is shown according to an example of the disclosure. For example, the base station 900 may be provided as a network device. With reference to FIG. 26, the base station 900 includes a processing component 922 and further includes one or more processors, and a memory resource denoted by a memory 932 for storing instructions, such as applications that may executed by the processing component 922. The applications stored in the memory 932 may include one or more modules each corresponding to a set of instructions. In addition, the processing component 922 is configured to execute instructions to execute any method, applied to the base station, of the foregoing methods.

The base station 900 may further include a power supply component 926 configured to execute power management of the base station 900, a wired or wireless network interface 950 configured to network the base station 900, and an input-output (I/O) interface 958. The base station 900 may operate an operating system, such as Windows Server™, Mac OS X™, Unix™, Linux™, FreeBSD™ and the like, stored in the memory 932.

Those skilled in the art will readily conceive of other implementation solutions of the disclosure after consideration of the description and implementation of the invention disclosed here. The disclosure is intended to cover any variation, use or adaptive change of the disclosure. The variation, use or adaptive change follows general principles of the disclosure and includes common general knowledge or conventional technical means in the technical art not disclosed in the disclosure. The description and the example are merely considered illustrative, and a true scope and spirit of the disclosure are indicated by the following claims.

It should be understood that the disclosure is not limited to precise structures described above and shown in the accompanying drawings, and various modifications and changes can be made without departing from the scope of the disclosure. The scope of the disclosure is merely limited by the appended claims.

1. A method for authentication and authorization, performed by an edge enabler client (EEC), the method comprising:
transmitting authentication and authorization information to an edge configuration server (ECS); wherein the authentication and authorization information is configured to request a token for service authorization.

2. The method according to claim 1, further comprising:
receiving the token transmitted by the ECS.

3. The method according to claim 2, wherein the receiving the token transmitted by the ECS comprises:
receiving, through a transport layer security (TLS) connection, the token transmitted by the ECS, wherein the token comprises at least one of the following:
a fully qualified domain name (FQDN) of the edge configuration server (ECS);
an EEC identifier (ID);
a generic public subscription identifier (GPSI);
an expected edge enabler server (EES) service name;
an FQDN of an EES;
effective time; and
a digital signature.

4. (canceled)

5. The method according to claim 1, wherein the authentication and authorization information comprises at least one of the following:
a bootstrapping transaction identifier (B-TID);
an encrypted EEC ID;
a key type indicator;
a generic public subscription identifier (GPSI); and
a message authentication code.

6. (canceled)

7. The method according to claim 5, wherein the message authentication code is a message authentication code for integrity (MAC-I) determined based on K_{ECS}, and is configured to protect integrity of the B-TID, the encrypted EEC ID, the GPSI and/or the key type indicator.

8. The method according to claim 1, further comprising at least one of the following:
obtaining a B-TID from a bootstrapping server function (BSF) of a home network during running of a generic bootstrapping architecture; and
determining a key K_{EEC-ECS} based on a key K_{ECS} and an EEC identifier (ID), and executing mutual identity authentication and/or establishment of a transport layer security (TLS) connection between the EEC and the ECS based on the key K_{EEC-ECS}.

9-10. (canceled)

11. A method for authentication and authorization, performed by an edge configuration server (ECS), the method comprising:
receiving authentication and authorization information transmitted by an edge enabler client (EEC); wherein the authentication and authorization information is configured to request a token for service authorization.

12-14. (canceled)

15. The method according to claim 11, further comprising:
in response to receiving the authentication and authorization information, determining a network to which the ECS is connected; and
in response to determining that an identifier of the network to which the ECS is connected is identical to an identifier of a public land mobile network of the EEC that is configured to establish a connection to the ECS, and the identifier of the public land mobile network of the EEC that is configured to establish a connection to the ECS is different from a home network identifier of the EEC, establishing a connection to the network to which the ECS is connected.

16. (canceled)

17. The method according to claim 15, further comprising at least one of the following:
determining the home network identifier of the EEC based on a B-TID; and
obtaining the identifier and/or an access type of the public land mobile network of the EEC that is configured to establish a connection to the ECS from a policy control function (PCF).

18. (canceled)

19. The method according to claim 15, further comprising: yp2 transmitting application request information to a Zn-Proxy in a home network of the EEC;
wherein the application request information comprises at least one of the following:
a B-TID received by the ECS;
a network application function (NAF) identifier (ID); and
a key type indicator.

20. The method according to claim 19, further comprising:
receiving application response information transmitted by the Zn-Proxy, wherein the application response information comprises a key K_{ECS} and/or effective time information of the key K_{ECS}.

21. The method according to claim 20, further comprising:
verifying integrity of the authentication and authorization information based on the key K_{ECS} and/or an MAC-I.

22. The method according to claim 21, wherein the verifying integrity of the authentication and authorization information based on the key K_{ECS} and/or the MAC-I comprises:
generating the MAC-I based on the key K_{ECS} and the authentication and authorization information;
comparing the generated MAC-I with an MAC-I of the authentication and authorization information; and
in response to determining that the generated MAC-I is consistent with the MAC-I of the authentication and authorization information, determining that the authentication and authorization information is not modified; or, in response to determining that the generated MAC-I is inconsistent with the MAC-I of the authentication and authorization information, determining that the authentication and authorization information is modified.

23. The method according to claim 21, further comprising:
in response to determining that the authentication and authorization information is modified, terminating an authentication and authorization process; or,
in response to determining that the authentication and authorization information is not modified, decrypting an encrypted EEC ID received by the ECS.

24. The method according to claim 23, further comprising:
based on the decrypted EEC ID, determining whether the EEC is authorized to execute a configuration request operation according to a predetermined policy; and
in response to determining that the EEC is not authorized to execute the configuration request operation, terminating the configuration request process.

25-26. (canceled)

27. The method according to claim 20, further comprising:
in response to determining that the mutual identity authentication succeeds and the TLS connection is established between the EEC and the ECS, generating the token for the EEC to request the service authorization; and
transmitting the token to the EEC.

28. (canceled)

29. The method according to claim 27, wherein the transmitting the token to the EEC comprises:
transmitting the token to the EEC through the TLS connection, wherein the token comprises at least one of the following:
a fully qualified domain name (FQDN) of the ECS;
the EEC identifier (ID);
a GPSI;
an expected EES service name;
an FQDN of an EES;
effective time; and
a digital signature.

30. (canceled)

31. A method for authentication and authorization, performed by a Zn interface proxy Zn-Proxy, the method comprising:
receiving application request information transmitted by an ECS; wherein the application request information comprises at least one of the following:
a B-TID received by the ECS;
a network application function (NAF) identifier (ID); and
a key type indicator.

32-34. (canceled)

35. The method according to claim 31, further comprising:
receiving, by a bootstrapping server function (BSF), the application request information transmitted by the Zn-Proxy;
determining a key K_{ECS} based on the application request information; and
transmitting application response information to the Zn-Proxy, wherein the application response information comprises the key K_{ECS} and/or effective time information of the key K_{ECS}.

36-41. (canceled)

42. A communication device, comprising:
a memory; and
one or more processors connected to the memory, and configured to implementing the method according to claim 1, executable instruction stored in the memory.

43. (canceled)
